(19) United States
(12) Patent Application Publication
(10) Pub. No.: US 2026/0065290 A1
(43) Pub. Date: Mar. 5, 2026

(54) AUTOMATED EVIDENCE COLLECTION WITHIN A CLOUD SERVICE

(71) Applicant: SAP SE, Walldorf (DE)

(72) Inventors: Johannes Hoenger, Berlin (DE); Anne Roessiger, Berlin (DE); Henrik Hempelmann, Hansestadt Havelberg (DE)

(21) Appl. No.: 18/820,845

(22) Filed: Aug. 30, 2024

(51) Int. Cl. G06Q 30/018; G06F 9/50; G06Q 10/0637

(52) U.S. Cl. CPC G06Q 30/018; G06F 9/5072; G06Q 10/0637; G06F 2209/508

(57) ABSTRACT

A trusted component can be deployed to a computing cluster that collects audit evidence inside the cluster continuously. Performing the evidence collection within the cloud service avoids extending access to cloud resources, since the cloud service already has access to the cloud resources being audited. Additionally, since the evidence collection component is deployed to production servers, existing processes for testing and verifying standards compliance will be applied to the evidence collection component, increasing the quality of the component as compared to less thoroughly vetted external solutions. The evidence collection component may run on a regular schedule and collect evidence regularly (e.g., daily). The relevant information is retrieved from logs generated by the services being audited. The retrieved data is stored in an object store. Thus, only the information published by the evidence collection component is made accessible to external tools, enhancing the security of the services.

### TECHNICAL FIELD

The subject matter disclosed herein generally relates to evidence collection for standards compliance, and more specifically, to automated evidence collection within a cloud service.

### BACKGROUND

Customers of cloud services rely on cloud service providers to implement the cloud services securely and in compliance with legal requirements. Cloud service providers may certify their products in cooperation with external auditors that validate that the service providers meet requirements for certification. Example certification standards include ISO27018, ISO22301, SOC 2 Type 1, SOC 2 Type 2, BSI C5, and CSA STAR. The external auditor checks for compliance with the standards at regular intervals. When audited, the cloud service provider presents the internal processes to the auditors and provides evidence that the processes are being followed.

### BRIEF DESCRIPTION OF THE DRAWINGS

FIG. 1 shows a network diagram illustrating an example network environment suitable for providing an automated evidence collection within a cloud service.

FIG. 2 shows a block diagram of an application server, suitable for providing automated evidence collection within a cloud service.

FIG. 3 is a block diagram of an object store, suitable for storing evidence gathered by automated evidence collection within a cloud service.

FIG. 4 illustrates a method for an auditing service, according to some example embodiments.

FIG. 5 shows a block diagram showing one example of a software architecture for a computing device.

FIG. 6 shows a block diagram of a machine in the example form of a computer system within which instructions may be executed for causing the machine to perform any one or more of the methodologies discussed herein.

### DETAILED DESCRIPTION

Example methods and systems are directed to improving auditing of cloud services. Evidence to confirm that a cloud service provider is complying with applicable standards may follow a certain pattern, which enables the cloud service provider to generate a similar set of evidence in each audit. The pieces of evidence may be retrieved manually, which is a repetitive task and is error prone. Additionally, this procedure requires manual access to productive clusters, which is a security and stability risk.

The external access process may be automated, but such external automated processes are typically not as well tested before use as processes that are deployed to production clusters. Accordingly, while automated external evidence gathering may be a better solution than manual external evidence gathering, further advantages arise from the systems of automated evidence collection within a cloud service that are disclosed herein.

In state of the art cloud infrastructure, a trusted component can be deployed that collects audit evidence inside the cluster continuously. For example, Kubernetes may be used to deploy and orchestrate the cloud services and the audit component may be deployed in a Kubernetes container.

Performing the evidence collection within the cloud service avoids extending access to cloud resources to additional audit users, since the cloud service already as access to the cloud resources being audited. Additionally, since the evidence collection component is deployed to production servers, existing processes for testing and verifying standards compliance will be applied to the evidence collection component, increasing the quality of the component as compared to less thoroughly vetted external solutions.

Additionally, since the evidence collection component ships with the product itself, the cloud service provider is enabled to provide the evidence collecting solution in all cloud contexts, including public cloud, private cloud, and sovereign cloud shipments. This allows automated evidence collection even for restricted private cloud environments that do not allow external tools to access the data being audited. A private cloud is a cloud computing environment in which all resources are for a single tenant. A public cloud is a cloud computing environment in which resources are provided to multiple tenants. A sovereign cloud is a public or a private cloud that provides services to comply with digital sovereignty requirements. For example, a country may require that all data regarding its citizens is stored in servers within the country's borders. Accordingly, a sovereign cloud located within the country may be needed for compliance.

The evidence collection component may run on a regular schedule and collect evidence regularly (e.g., daily). The relevant information is retrieved from logs generated by the services being audited. The retrieved data is stored in an object store (e.g., Amazon web services (AWS) S3). Thus, only the information published by the evidence collection component is made accessible to external tools, enhancing the security of the services.

The object store may be certified, encrypted, access-protected, overwrite-proof, tamper-proof, or any suitable combination thereof. The access to the object store may be protected by dedicated access rights that are only granted to the cloud service provider for evidence retrieval. Using the dedicated access rights is more secure and less error prone than existing external access solutions that give the cloud service provider access to the Kubernetes cluster resources. The object store implementation may store and transfer less data than existing solutions because the filtering and selecting of information is performed within the service rather than being transferred across a network for processing at a different location.

By using the systems and methods herein, a service provider system is improved by adding built-in auditing functionality. Services are typically audited by using external tools to access substantial data from the service and processing the accessed data on a separate device. By contrast, the built-in auditing functionality disclosed herein transfers less data across a network and improves security for the services being audited, thus improving the functionality of service provider systems.

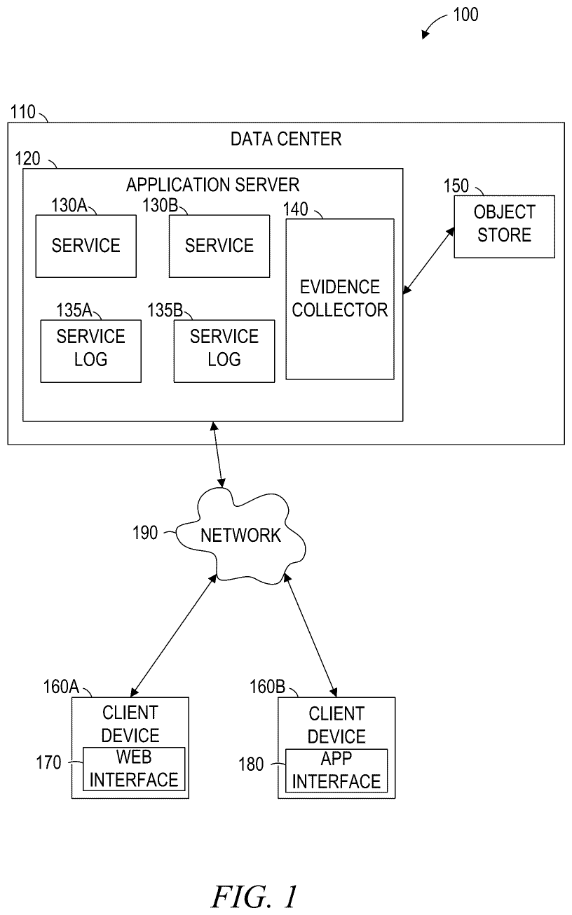

FIG. 1 shows a network diagram illustrating an example network environment 100 suitable for providing an automated evidence collection within a cloud service. The network environment 100 includes data center 110, client devices 160A and 160B, and a network 190. The data center 110 comprises an application server 120 in communication with an object store 150 (e.g., a database server). Multiple services 130A, 130B run on the application server 120 and generate corresponding service logs 135A, 135B. The evidence collector 140 accesses the service logs 135A-135B and, based on the accessed data, stores objects in the object store 150.

The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

An application running on the application server 120 may provide services to the client devices 160A and 160B. For example, a user of the client device 160A may be an employee of a business using a business application. The user may use the services to generate invoices, manage employees, develop other applications, or any suitable combination thereof. The user interface for the application may be presented using a web interface 170 or an app interface 180.

The evidence collector 140 may communicate with the services 130 via a representational state transfer (REST) application programming interface (API). A REST API uses stateless communications, in which each request is separate from each other request rather than having a server component maintain a state for a communication session between requests. The client devices 160 may also communicate with the evidence collector 140 via a REST API. As used herein, an evidence collector is a software component that executes on one or more hardware processors within a trusted environment (e.g., a Kubernetes cluster or Kubernetes namespace) to gather compliance data regarding other processes that also execute within the trusted environment.

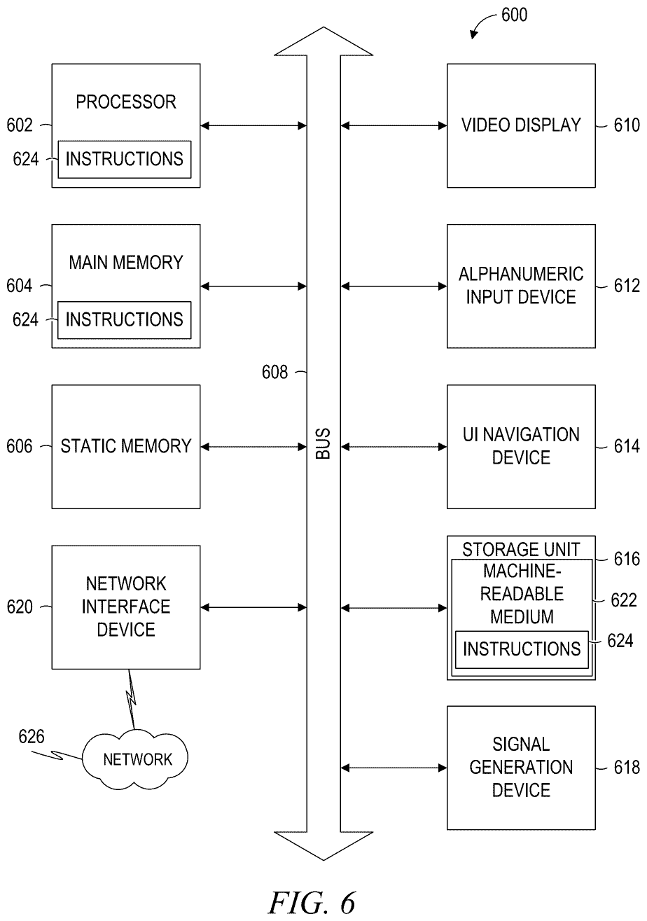

The application server 120, the object store 150, and the client devices 160A-160B may each be implemented in a computer system, in whole or in part, as described below with respect to FIG. 6. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 6. As used herein, an “object store” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the object store 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one application server 120, two services 130, two client devices 160, and the like), any number of each element is contemplated. For example, the application server 120 may be one of dozens or hundreds of active and standby servers and provide services to millions of client devices. Likewise, dozens or hundreds of services 130 may execute on the application server 120 and the evidence collector 140 may access dozens or hundreds of service logs 135 to generate data for the object store 150 (or multiple object stores 150).

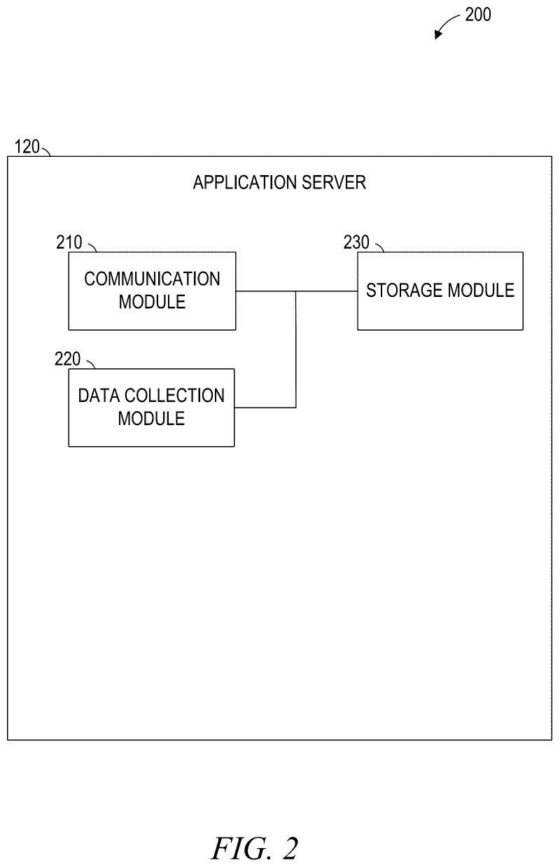

FIG. 2 shows a block diagram 200 of the application server 120, suitable for providing automated evidence collection within a cloud service. The application server 120 is shown as including a communication module 210, a data collection module 220, and a storage module 230, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 160A, a request for a user interface. The application server 120 may generate the user interface (e.g., as a web page) and send, via the communication module 210, the user interface to the client device 160A for display to a user.

The data collection module 220 implements the evidence collector 140 of FIG. 1 and accesses the service logs 135. Data from the service logs 135 is processed by the data collection module 220 and the results are sent by the communication module 210 to the object store 150.

Data, metadata, documents, instructions, or any suitable combination thereof may be stored and accessed by the storage module 250. For example, local storage of the application server 120, such as a hard drive, may be used. As another example, network storage may be accessed by the storage module 250 via the network 190.

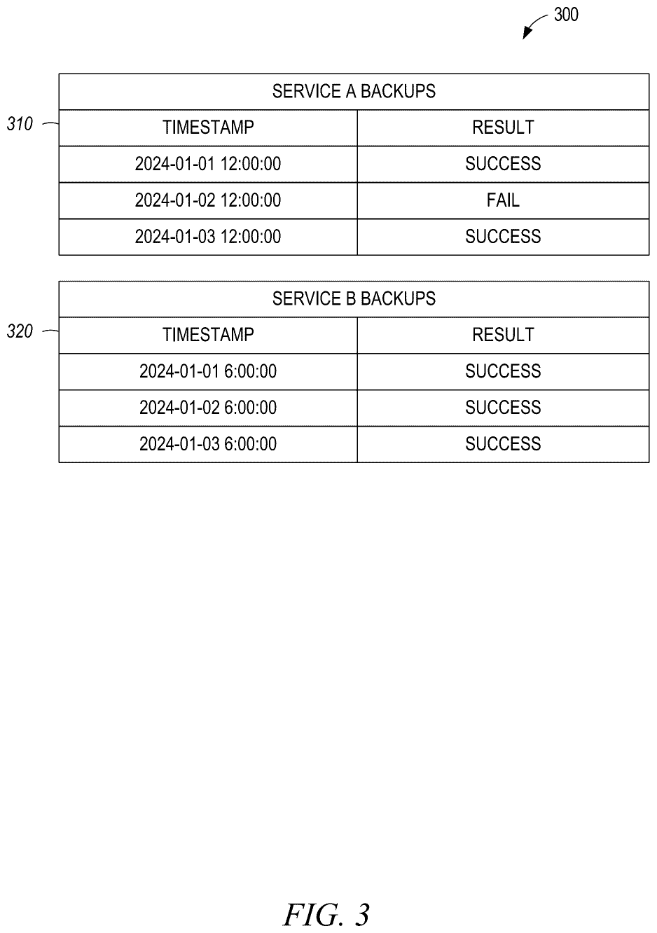

FIG. 3 is a block diagram 300 of an object store, suitable for storing evidence gathered by automated evidence collection within a cloud service. The table 310 stores data for a first service (e.g., the service 130A of FIG. 1) and the table 320 stores data for a second service (e.g., the service 130B of FIG. 1).

The service logs 135 may contain a variety of log entries that include information about the actions performed by the corresponding service 130. Example log entries include start up, shut down, data access, client connections and disconnections, backup attempts, or any suitable combination thereof.

In this example, the compliance rules being for auditing of the application server 120 relate to determining whether backups for the services 130 were successful. Accordingly, the evidence collector 140 accesses the service logs 135 to extract information about data backups attempted by the services 130. The results determined by the evidence collector 140 are stored in the tables 310 and 320. Each row of the tables 310 and 320 indicates a timestamp for an attempted backup and whether the backup was successful.

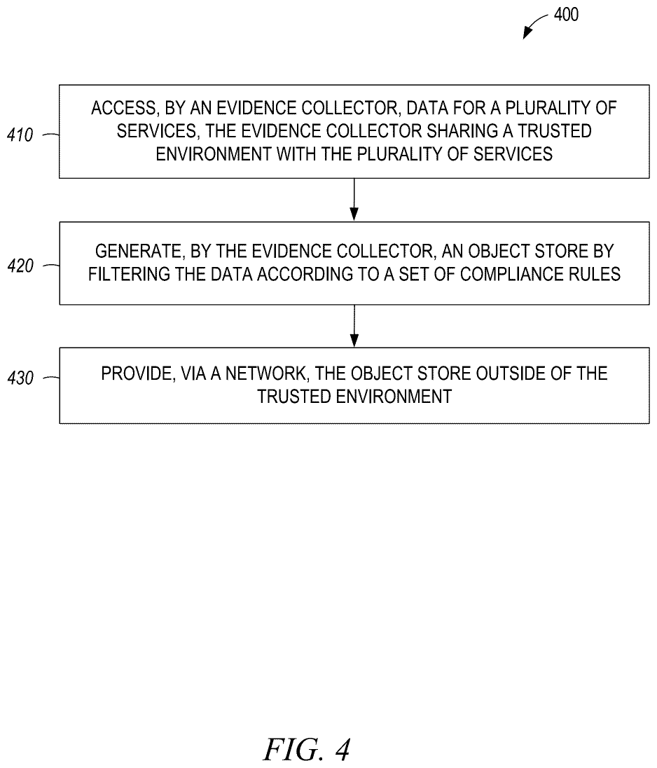

FIG. 4 illustrates a method 400 for an auditing service, according to some example embodiments. The method 400 includes operations 410, 420, and 430. By way of example and not limitation, the method 400 is described as being performed by the application server 120 of FIG. 1, using the object store of FIG. 3.

In operation 410, the evidence collector 140 accesses data (e.g., the service logs 135) for a plurality of services (e.g., the services 130). The evidence collector 140 shares a trusted environment with the plurality of services. For example, the evidence collector 140 and the plurality of services 130 may execute on the same application server 120. As another example, the evidence collector 140 and the plurality of services 130 may execute on different computing devices within a local area network (LAN). The LAN may be configured to allow greater freedom of communication between the computing devices within the LAN than between the LAN and other computing devices connected via a wide area network (WAN). The evidence collector 140 may access the data for the plurality of services via a REST API.

The evidence collector 140 generates, in operation 420, an object store by filtering the data according to a set of compliance rules. The set of compliance rules may include rules for compliance with an International Standards Organization (ISO) standard, a Security Operations Center (SOC) standard, a British Standards Institution (BSI) standard, a Compliance, Safety, Accountability (CSA) standard, or any suitable combination thereof.

The set of compliance rules determine the portion of the data to be added to the object store and the portion of the data to be ignored. A portion of an example service log 135 is below.

2024-01-01 1:34:56 Service A start
2024-01-01 1:35:27 Database access, 450 rows
2024-01-01 1:38:19 Send data to destination
2024-01-01 11:55:00 Backup start
2024-01-01 12:00:00 Backup success
...
2024-01-02 11:55:00 Backup start
2024-01-02 12:00:00 Backup fail

The compliance rules may state that log entries containing “backup success” or “backup fail” are of interest, and define the format of the records to which the log entries of interest are recorded. Accordingly, the filtering of the data may comprise identifying lines of log files that contain a key word or key phrase (e.g., “backup” as a key word or “backup success” as a key phrase comprising multiple words). Thus, the log entries with timestamps 2024 Jan. 1 12:00:00 and 2024 Jan. 2 12:00:00 result in the first two rows of the table 310 of FIG. 3 being stored. The remaining log entries are ignored and no rows are created for those log entries.

In operation 430, the application server 120 provides, via a network, the object store outside of the trusted environment. For example, the object store 150 of FIG. 1 may be accessible by the client devices 160, which are outside of the trusted environment in which the services 130 and the evidence collector 140 run. As a result, a user of one of the client devices 160 may access the object store to determine if audited services are complying with standards even though the client device 160 is unable to directly access the service logs 135.

The data center 110 may receive via a REST API, a request for the object store. For example, the client device 160A may request the object store 150 via a hypertext transport protocol (HTTP) interface. In response, some or all of the object store 150 is sent via the network 190 to the requesting client device 160A. The received data may be displayed on a display device, further processing may be performed to determine if the application server 120 is in compliance with applicable standards, results of the further processing may be displayed on the display device, or any suitable combination thereof.

Prior to the performance of the method 400, the services 130 and the evidence collector 140 are deployed to the application server 120. In some example embodiments, the evidence collector is deployed in accordance with production software deployment requirements. For example, regression testing may be performed on the services 130 and the evidence collector 140 on a testing server before they are deployed to the application server 120.

In some example embodiments, the use of the evidence collector prevents unfiltered data from being provided outside of the system. For example, in a system without an evidence collector that filters data and populates the object store with the filtered data, determining if the application server 120 is in compliance would be performed by allowing the client device 160 to access the service logs 135A. Using the evidence collector, only the filtered data in the object store 150 is made accessible outside of the data center 110, enhancing data control.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: accessing, by an evidence collector, data for a plurality of services, the evidence collector sharing a trusted environment with the plurality of services; generating, by the evidence collector, an object store by filtering the data according to a set of compliance rules; and providing, via a network, the object store outside of the trusted environment.

In Example 2, the subject matter of Example 1, wherein the accessing of the data for the plurality of services is via a representational state transfer (REST) application programming interface (API).

In Example 3, the subject matter of Examples 1-2, wherein the operations further comprise: receiving, via a representational state transfer (REST) application programming interface (API), a request for the object store.

In Example 4, the subject matter of Examples 1-3, wherein the operations further comprise: deploying the evidence collector in accordance with production software deployment requirements.

In Example 5, the subject matter of Examples 1-4, wherein the filtering of the data comprises identifying lines of log files that contain a key word.

In Example 6, the subject matter of Examples 1-5, wherein the compliance rules comprise rules for compliance with an International Standards Organization (ISO) standard.

In Example 7, the subject matter of Examples 1-6, wherein the evidence collector prevents unfiltered data from being provided outside of the trusted environment.

Example 8 is a non-transitory computer-readable medium that stores instructions that, when executed by one or more processors, cause the one or more processors to perform operations comprising: accessing, by an evidence collector, data for a plurality of services, the evidence collector sharing a trusted environment with the plurality of services; generating, by the evidence collector, an object store by filtering the data according to a set of compliance rules; and providing, via a network, the object store outside of the trusted environment.

In Example 9, the subject matter of Example 8, wherein the accessing of the data for the plurality of services is via a representational state transfer (REST) application programming interface (API).

In Example 10, the subject matter of Examples 8-9, wherein the operations further comprise: receiving, via a representational state transfer (REST) application programming interface (API), a request for the object store.

In Example 11, the subject matter of Examples 8-10, wherein the operations further comprise: deploying the evidence collector in accordance with production software deployment requirements.

In Example 12, the subject matter of Examples 8-11, wherein the filtering of the data comprises identifying lines of log files that contain a key word.

In Example 13, the subject matter of Examples 8-12, wherein the compliance rules comprise rules for compliance with an International Standards Organization (ISO) standard.

In Example 14, the subject matter of Examples 8-13, wherein the evidence collector prevents unfiltered data from being provided outside of the trusted environment.

Example 15 is a method comprising: accessing, by an evidence collector, data for a plurality of services, the evidence collector sharing a trusted environment with the plurality of services; generating, by the evidence collector, an object store by filtering the data according to a set of compliance rules; and providing, via a network, the object store outside of the trusted environment.

In Example 16, the subject matter of Example 15, wherein the accessing of the data for the plurality of services is via a representational state transfer (REST) application programming interface (API).

In Example 17, the subject matter of Examples 15-16 includes receiving, via a representational state transfer (REST) application programming interface (API), a request for the object store.

In Example 18, the subject matter of Examples 15-17 includes deploying the evidence collector in accordance with production software deployment requirements.

In Example 19, the subject matter of Examples 15-18, wherein the filtering of the data comprises identifying lines of log files that contain a key word.

In Example 20, the subject matter of Examples 15-19, wherein the compliance rules comprise rules for compliance with an International Standards Organization (ISO) standard.

Example 21 is an apparatus comprising means to implement any of Examples 1-20.

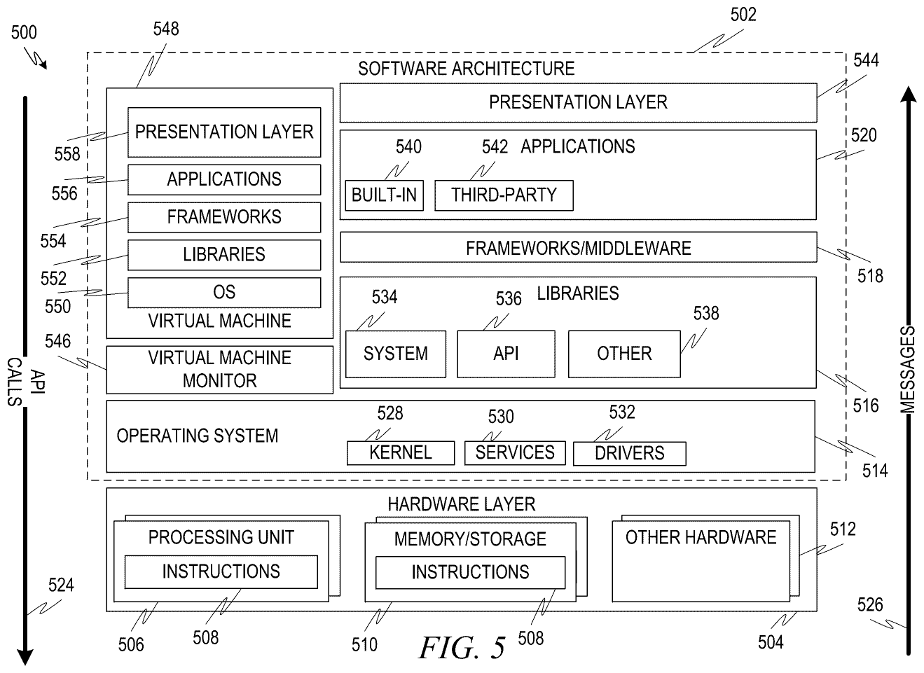

FIG. 5 shows a block diagram 500 showing one example of a software architecture 502 for a computing device. The software architecture 502 may be used in conjunction with various hardware architectures, for example, as described herein. FIG. 5 is merely a non-limiting example of a software architecture, and many other architectures may be implemented to facilitate the functionality described herein. A representative hardware layer 504 is illustrated and can represent, for example, any of the above referenced computing devices. In some examples, the hardware layer 504 may be implemented according to the architecture of the computer system of FIG. 5.

The representative hardware layer 504 comprises one or more processing units 506 having associated executable instructions 508. Executable instructions 508 represent the executable instructions of the software architecture 502, including implementation of the methods, modules, subsystems, and components, and so forth described herein and may also include memory and/or storage modules 510, which also have executable instructions 508. Hardware layer 504 may also comprise other hardware as indicated by other hardware 512 which represents any other hardware of the hardware layer 504, such as the other hardware illustrated as part of the software architecture 502.

In the example architecture of FIG. 5, the software architecture 502 may be conceptualized as a stack of layers where each layer provides particular functionality. For example, the software architecture 502 may include layers such as an operating system 514, libraries 516, frameworks/middleware 518, applications 520, and presentation layer 544. Operationally, the applications 520 and/or other components within the layers may invoke application programming interface (API) calls 524 through the software stack and access a response, returned values, and so forth illustrated as messages 526 in response to the API calls 524. The layers illustrated are representative in nature and not all software architectures have all layers. For example, some mobile or special purpose operating systems may not provide a frameworks/middleware 518 layer, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. In some examples, the services 530 include an interrupt service. The interrupt service may detect the receipt of an interrupt and, in response, cause the software architecture 502 to pause its current processing and execute an interrupt service routine (ISR) when an interrupt is accessed.

The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 516 may include system libraries 534 (e.g., C standard library) that may provide functions such as memory allocation functions, string manipulation functions, mathematic functions, and the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 516 may also include a wide variety of other libraries 538 to provide many other APIs to the applications 520 and other software components/modules.

The frameworks/middleware 518 may provide a higher-level common infrastructure that may be utilized by the applications 520 and/or other software components/modules. For example, the frameworks/middleware 518 may provide various graphic user interface (GUI) functions, high-level resource management, high-level location services, and so forth. The frameworks/middleware 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any of the built-in applications as well as a broad assortment of other applications. In a specific example, the third-party application 542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 542 may invoke the API calls 524 provided by the mobile operating system such as operating system 514 to facilitate functionality described herein.

The applications 520 may utilize built-in operating system functions (e.g., kernel 528, services 530 and/or drivers 532), libraries (e.g., system libraries 534, API libraries 536, and other libraries 538), and frameworks/middleware 518 to create user interfaces to interact with users of the system. Alternatively, or additionally, in some systems, interactions with a user may occur through a presentation layer, such as presentation layer 544. In these systems, the application/module “logic” can be separated from the aspects of the application/module that interact with a user.

Some software architectures utilize virtual machines. In the example of FIG. 5, this is illustrated by virtual machine 548. A virtual machine creates a software environment where applications/modules can execute as if they were executing on a hardware computing device. A virtual machine is hosted by a host operating system (operating system 514) and typically, although not always, has a virtual machine monitor 546, which manages the operation of the virtual machine 548 as well as the interface with the host operating system (i.e., operating system 514). A software architecture executes within the virtual machine 548 such as an operating system 550, libraries 552, frameworks/middleware 554, applications 556 and/or presentation layer 558. These layers of software architecture executing within the virtual machine 548 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 6 shows a block diagram of a machine in the example form of a computer system 600 within which instructions 624 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube [CRT]). The computer system 600 also includes an alphanumeric input device 612 (e.g., a keyboard or a touch-sensitive display screen), a user interface (UI) navigation (or cursor control) device 614 (e.g., a mouse), a storage unit 616, a signal generation device 618 (e.g., a speaker), and a network interface device 620.

### Machine-Readable Medium

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting a machine-readable medium 622.

While the machine-readable medium 622 is shown in FIG. 6 to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with the instructions 624. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
accessing, by an evidence collector, data for a plurality of services, the evidence collector sharing a trusted environment with the plurality of services;
generating, by the evidence collector, an object store by filtering the data according to a set of compliance rules; and
providing, via a network, the object store outside of the trusted environment.

2. The system of claim 1, wherein the accessing of the data for the plurality of services is via a representational state transfer (REST) application programming interface (API).

3. The system of claim 1, wherein the operations further comprise:
receiving, via a representational state transfer (REST) application programming interface (API), a request for the object store.

4. The system of claim 1, wherein the operations further comprise:
deploying the evidence collector in accordance with production software deployment requirements.

5. The system of claim 1, wherein the filtering of the data comprises identifying lines of log files that contain a key word.

6. The system of claim 1, wherein the compliance rules comprise rules for compliance with an International Standards Organization (ISO) standard.

7. The system of claim 1, wherein the evidence collector prevents unfiltered data from being provided outside of the trusted environment.

8. A non-transitory computer-readable medium that stores instructions that, when executed by one or more processors, cause the one or more processors to perform operations comprising:
accessing, by an evidence collector, data for a plurality of services, the evidence collector sharing a trusted environment with the plurality of services;
generating, by the evidence collector, an object store by filtering the data according to a set of compliance rules; and
providing, via a network, the object store outside of the trusted environment.

9. The non-transitory computer-readable medium of claim 8, wherein the accessing of the data for the plurality of services is via a representational state transfer (REST) application programming interface (API).

10. The non-transitory computer-readable medium of claim 8, wherein the operations further comprise:
receiving, via a representational state transfer (REST) application programming interface (API), a request for the object store.

11. The non-transitory computer-readable medium of claim 8, wherein the operations further comprise:
deploying the evidence collector in accordance with production software deployment requirements.

12. The non-transitory computer-readable medium of claim 8, wherein the filtering of the data comprises identifying lines of log files that contain a key word.

13. The non-transitory computer-readable medium of claim 8, wherein the compliance rules comprise rules for compliance with an International Standards Organization (ISO) standard.

14. The non-transitory computer-readable medium of claim 8, wherein the evidence collector prevents unfiltered data from being provided outside of the trusted environment.

15. A method comprising:
accessing, by an evidence collector, data for a plurality of services, the evidence collector sharing a trusted environment with the plurality of services;
generating, by the evidence collector, an object store by filtering the data according to a set of compliance rules; and
providing, via a network, the object store outside of the trusted environment.

16. The method of claim 15, wherein the accessing of the data for the plurality of services is via a representational state transfer (REST) application programming interface (API).

17. The method of claim 15, further comprising:
receiving, via a representational state transfer (REST) application programming interface (API), a request for the object store.

18. The method of claim 15, further comprising:
deploying the evidence collector in accordance with production software deployment requirements.

19. The method of claim 15, wherein the filtering of the data comprises identifying lines of log files that contain a key word.

20. The method of claim 15, wherein the compliance rules comprise rules for compliance with an International Standards Organization (ISO) standard.
